(19) United States
(12) Patent Application Publication
(10) Pub. No.: US 2009/0250907 A1
(43) Pub. Date: Oct. 8, 2009

(54) VEHICLE SUSPENSION LEVELLING CONTROL

(75) Inventors: Stefan Preijert, Goteborg (SE); Ingela Stjarnvy, Goteborg (SE)

Correspondence Address: WRB-IP LLP, 1217 KING STREET, ALEXANDRIA, VA, 22314, US

(73) Assignee: Volvo Lastvagnar AB, Goteborg (SE)

(21) Appl. No.: 12/305,400

(22) PCT Filed: Jun. 21, 2007
(86) PCT No.: PCT/SE07/00611

§ 371 Date: Dec. 18, 2008

(30) Foreign Application Priority Data
Jul. 5, 2006 (SE) 0601482-3

(51) Int. Cl. B60G 5/00

(52) U.S. Cl. 280/682

(57) ABSTRACT

A front wheel suspension system is arranged to support a vehicle chassis suspended for movement relative to its wheels. The suspension system includes a double leaf spring arrangement on each side of the chassis. A first leaf spring connection arrangement pivotably connects each leaf spring to the chassis at a first end. A second leaf spring connection arrangement is connected to each leaf spring at its opposite, second end by a linkage arrangement which is carried on a pivot pin pivotably attached to a first arm of a lever that is supported by a pivotal connection on the vehicle chassis. A length adjustable unit is mounted on each side of the chassis, and each length adjustable unit being operatively connected to a second arm of the lever for each leaf spring, wherein each length adjustable unit is arranged to effect a substantially vertical displacement of the second end of each leaf spring relative to the chassis.

### BACKGROUND AND SUMMARY

The invention relates to a leaf spring type front suspension for a vehicle with a double front axle provided with a vehicle height adjusting function with which a vehicle frame ground clearance can be controlled in response to driver demand or road surface conditions.

Most vehicle suspensions of the beam axle type incorporate leaf springs, wherein the usual leaf spring arrangement utilises a beam axle extending between two ground-engaging wheels. The beam axle is usually bolted to the centre of each of the two leaf springs, each leaf spring being normally mounted to the vehicle chassis at one end by means of a fixed bracket and at the other end to a shackle. The fixed bracket provides an anchor point whilst the shackle allows the spring to lengthen or shorten according to the loads applied.

A vehicle suspension of this type is shown in JP 07-251 622, describing a leaf spring type front suspension provided with a vehicle height adjusting function with which a frame ground height can be lifted in a suspension position on a front axle side during travel on a rough road. According to this solution, one end of the leaf spring is mounted to a frame via a front spring bracket, while the other end is journalled to the lower end of a shackle. The shackle is journalled to one arm of a crank arm and the crank arm itself is journalled to the frame via a bracket. The other arm of the crank arm is journalled in a piston rod of a hydraulic cylinder fixed to the frame.

This type of beam axle suspension has proved satisfactory for vehicles with a single front axle. However, the above solution can not be applied to vehicles with a double front axle. The solution used for the single axle suspension does not allow load sharing between two front axles using this concept, as each leaf spring is individually controlled. Similarly, vehicle height adjustment would require simultaneous control of four individual hydraulic cylinders.

The above problems are solved by a suspension according to the invention, allowing a driver to change the driving height for a front suspension in a vehicle with a double front axle suspended by leaf springs. According to the invention the adjustable height control may also be operated while the vehicle is moving, allowing the driver to change quickly from an off-road setting, with an increased ride height for rough roads or terrain, to a highway setting for smooth tarmac or paved roads.

According to a preferred embodiment, the invention relates to a front wheel suspension system arranged to support a vehicle chassis suspended for movement relative to its wheels. The suspension system comprises a pair of longitudinally separated leaf springs on each side of the chassis. A first leaf spring connection means may be arranged for pivotably connecting each said leaf spring to the chassis at a first end. A second leaf spring connection means may be connected to each said leaf spring at its opposite, second end by a linkage means, such as a shackle, which is carried on a pivot pin or a shackle pin. The pivot pin may be pivotably attached to a first arm of a lever that may be supported by a pivotal connection on the trailer chassis.

A length adjustable unit may be provided on each side of the chassis, and each said length adjustable unit may be operatively connected to a second arm of said lever for each said leaf spring. Each said length adjustable unit may be arranged to effect a substantially vertical displacement of the second end of each leaf spring relative to the chassis. In this way, actuation of the length adjustable unit will cause the lever to pivot about its pivotal connection and simultaneously displace the second end of each leaf spring relative to the chassis in order to adjust the height of the chassis relative to the ground.

The length adjustable unit may be mechanically, electrically or hydraulically operated. According to the invention, the length adjustable unit preferably comprises a rack and pinion unit or a ball screw unit. However, it may also be possible to use a double-acting fluid damper comprising a piston cylinder combination. The choice of a suitable application may depend on factor such as maximum load to be carried by the front axles or the required accuracy of the height adjustment unit.

In order to increase the ride comfort for the driver, the length adjustable unit may also comprise a progressive spring. This spring may be integrated in the length adjustable unit and can comprise a progressive rubber, steel or gas hydraulic spring or damper. Such a solution may add a very low total spring rate at a relatively small spring travel before the leaf spring will deflect, while adding a relatively high spring rate at larger deflections of the leaf spring. The progressive spring may have a spring travel as little as ±10 mm. In the above example, the “total spring rate” referred to relates to a suspension comprising a pair of leaf springs and progressive spring.

The length adjustable unit may preferably be operatively connected to a lever that is arranged to carry a rear end of the respective leaf spring. However, it may also be arranged to carry a front end of the respective leaf spring.

According to an alternative embodiment, one end of said length adjustable unit may be attached to the chassis between adjacent ends of the respective leaf springs. The length adjustable unit may be fixedly attached to the chassis, whereby an adjustable component, such as a rod or piston, may extend downwards to a position between the adjacent ends of the respective leaf springs. An opposite, position adjustable end of the length adjustable unit may be provided with a pivot joint operatively connected to the second arm of each lever by means of a pivotable linkage. The pivot joint of the length adjustable unit may be connected to the respective second arm of each lever by shackles of substantially equal length.

The first leaf spring connection means may be a spring hanger arranged to support a leaf spring front or rear eye. The second leaf spring connection means may comprise a linkage means such as a shackle pivotably attached to support a leaf spring front or rear eye. The linkage means is connected to the first arm of the lever, which lever has a pivotal connection that may be attached to the chassis by means of a spring hanger. Each lever comprises first and second arms joined at a point of intersection and are pivotably attached to the trailer chassis at said point of intersection. The lever may preferably, but not necessarily be arranged so that the first arm is longer than the second arm. An angle enclosed by the first and second arms may be between 45° and 135°.

A suspension according to the invention allows a driver to adjust the length of the length adjustable unit in order to change the driving height for a front suspension in a vehicle with a double front axle suspended by leaf springs. According to one embodiment the adjustable height control may be operated while the vehicle is moving. This allows the driver to change quickly from an off-road setting, with an increased ride height for rough roads or terrain, to a highway setting for smooth tarmac or paved roads. According to a further embodiment the adjustable height control may be used for stepless adjustment of the front ride height to a level desired by the driver. The desired ride height may be set or controlled by adjusting a single component in the double front axle suspension. The adjustment may be carried out manually by the driver, in order to set a particular ride height, or automatically by a control unit, which control unit can be set to maintain a desired or preset ride height in response to at least one sensed parameter, such as an actual ride height or vehicle load. The adjustment may be achieved by a variation of the rod length of a mechanical or electrically operated unit or a pneumatically or hydraulically actuated cylinder.

A suspension according to the invention can also be used as a load sharing installation on a double front leaf spring suspension, wherein the length adjustable unit may act as a load sharing link rod, that translates the movement of either lever from the first axle to the second axle.

With an adjustable height unit, especially on trucks with load sharing for the double axles, the front section of the chassis can be lowered to provide a more aerodynamic front when driving at relatively high speeds on good roads. At the same time, the chassis can be lifted to give an improved ground clearance and a greater approach angle for the wheels on the foremost axle when approaching more uneven road conditions or when driving in off road conditions, while maintaining an improved behaviour from the suspension provided by the load sharing mechanism.

If additional ride comfort is desired, this may be achieved simply by adding a single comfort spring, or progressive spring in each of the two length adjusting units. This allows a noticeable increase in ride comfort for a vehicle with two front axles with a minimum of modification of the suspension system.

### BRIEF DESCRIPTION OF DRAWINGS

In the following text, the invention will be described in detail with reference to the attached drawings. These schematic drawings are used for illustration only and do not in any way limit the scope of the invention. In the drawings:

FIG. 1 shows a schematic illustration of a suspension system according a first embodiment of the invention;

FIG. 2 shows a schematic illustration of a suspension system according to an alternative embodiment of the invention.

### DETAILED DESCRIPTION

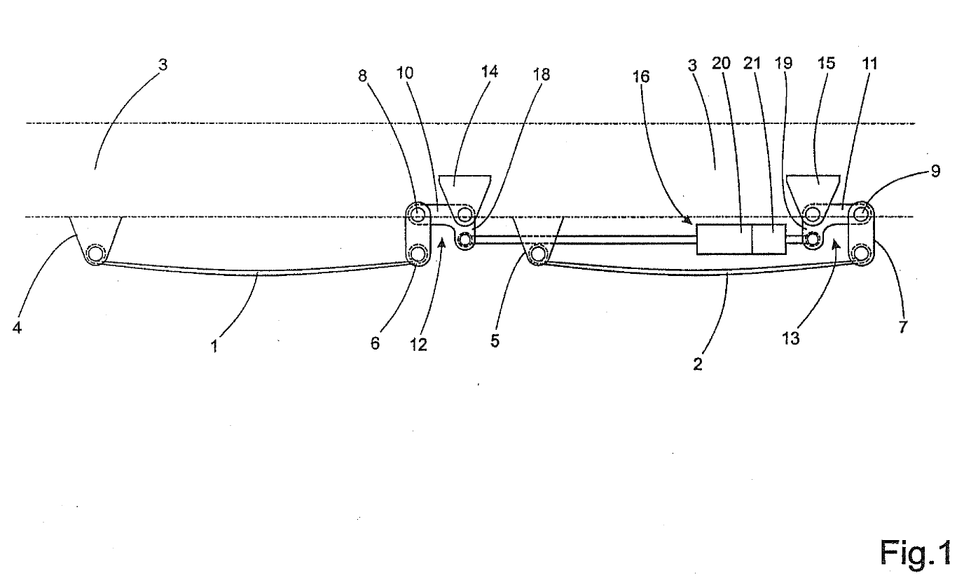

FIG. 1 shows a schematic front wheel suspension system according to a first embodiment of the invention. The suspension system is arranged to support a vehicle chassis suspended for movement relative to its wheels (not shown). The suspension system comprises first and second longitudinally separated leaf springs 1, 2 on each side of a chassis comprising a pair of substantially parallel longitudinal beams 3 (indicated in dash-dotted lines). Each leaf spring supports a wheel axle (not shown) attached to its respective leaf spring by a suitable clamping means. The first and second leaf springs 1, 2 are each provided with a front connection means in the form of a spring hanger 4, 5 arranged for pivotably connecting a leaf eye of each said leaf spring 1, 2 to the chassis 3 at their front ends. A second leaf spring connection means is connected to each said leaf spring 1, 2 at their opposite, rear ends. The second leaf spring connection means comprises a linkage means in the form of a shackle 6, 7, which is pivotably connected to a leaf eye of its respective leaf spring 1, 2. Each shackle 6, 7 is carried on a shackle pin 8, 9 pivotably attached to a first arm 10, 11 of a lever 12, 13 that is supported by a pivotal connection in the form of a spring hanger 14, 15 attached to the trailer chassis 3. In the example shown, the lever 12, 13 is substantially L-shaped. As can be seen from the figure, the rear, second leaf spring connection means are substantially identical, but mirrored. Consequently, the first arm 10 of the front lever 12 carrying the rear end of the first leaf spring 1 is located to the front of its spring hanger 14, while the corresponding first arm 11 of the rear lever 13 carrying the second leaf spring 2 is located to the rear of its spring hanger 15. In the shown example, the spring hangers 4, 5, 14, 15 are attached to the chassis 3 in positions suitable for a chosen size of leaf spring, a required ground clearance and/or other relevant parameters.

A length adjustable unit 16 (one shown) is provided on each side of the chassis 3, wherein each length adjustable unit 16 may be operatively connected to a second arm 18, 19 of the respective lever 12, 13 for each said leaf spring 1, 2. Each said length adjustable unit 16 is arranged to effect a substantially vertical displacement of the rear, second end of each leaf spring 1, 2 relative to the chassis 3 by causing a simultaneous pivoting movement of the lever arms 12, 13. In this way, actuation of the length adjustable unit 16 will cause the levers 12, 13 to pivot about their pivotal connections in their respective spring hanger 14, 15 and simultaneously displace the second end of each leaf spring 1, 2 relative to the chassis 3 in order to adjust the height of the chassis relative to the ground. For instance, by shortening the length of the length adjustable unit 16 in FIG. 1, the front lever 12 will be rotated anticlockwise, while the rear lever 13 will be rotated clockwise. Each lever 12, 13 will act on their respective shackle 6, 7 to displace the rear end of each leaf spring downwards, away from the chassis 3, to increase the ground clearance at the front of the vehicle. The movement of the end of the first arm 10, 11 of the respective lever 12, 13 will in fact follow an arc determined by the distance between the pivot axis of the lever 12, 13 and the shackle pin 8, 9 at the end of the first arm 10, 11. However, this deviation from a vertical plane is compensated for by the shackle 6, 7 carried on the shackle pin 8, 9.

In this example, the length adjustable unit comprises an actuator in the form of a rack-and-pinion device 20 that is hydraulically controlled for length adjustment. A control means (not shown) for actuating the length adjustable unit 16 can be provided in the drivers compartment, allowing manual and/or automatic control of the unit. An optional feature that can be integrated in the length adjustable unit is a spring unit 21. The spring unit 21 is mounted in series with the actuator 20 to form an assembled unit and contributes to the ride comfort for the driver. In the example shown, the spring unit is a progressive rubber spring having a spring travel of ±10 mm. The assembled actuator and spring unit 20, 21 is provided with rods extending from either end of the assembled unit, wherein each rod is connected to a pivot pin on the second arm 18, 19 of the respective lever 12, 13.

In the example described in connection with FIG. 1 the first leaf spring 1 is assumed to be located in front of the second leaf spring 2. The reverse situation is of course possible.

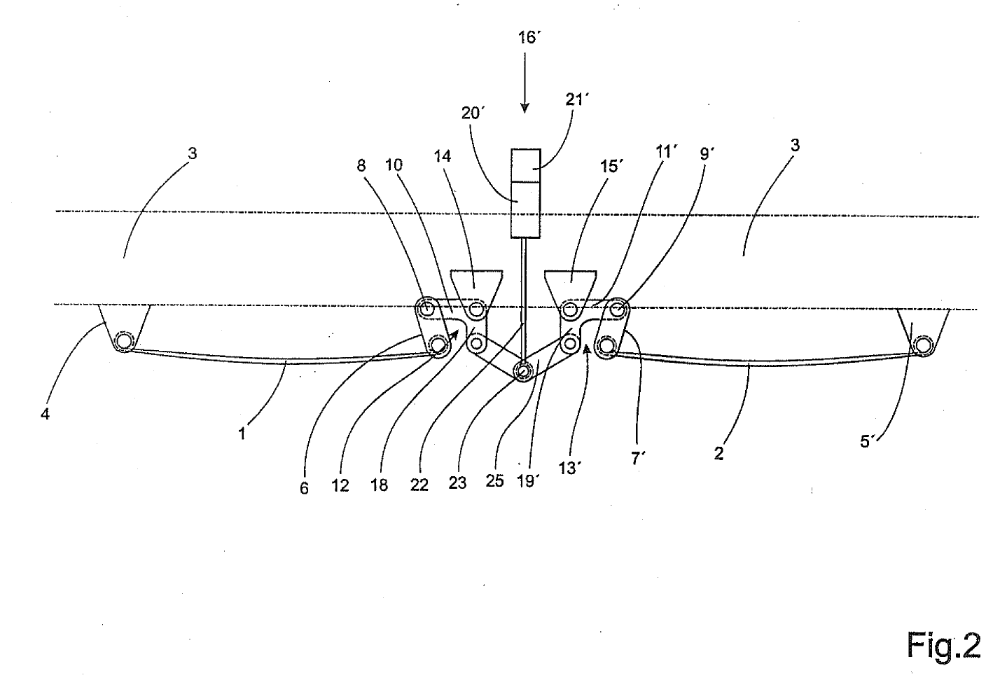

FIG. 2 shows an alternative embodiment of the invention. As in the first embodiment, the suspension system comprises first and second longitudinally separated leaf springs 1, 2 on each side of a chassis comprising a pair of substantially parallel longitudinal beams 3 (indicated in dash-dotted lines). The component parts of this embodiment are substantially identical to that of FIG. 1, whereby a reference number indicating an identical but repositioned component is identified by an apostrophe. The first leaf spring 1 is provided with a front connection means in the form of a spring hanger 4 arranged for pivotably connecting a leaf eye of the front leaf spring 1 to the chassis 3 at its front end. This arrangement of the first leaf spring 1 is identical to that shown in FIG. 1. The second leaf spring 2 is provided with a front connection means in the form of a spring hanger 5′ arranged for pivotably connecting a leaf eye of the rear leaf spring 2 to the chassis 3 at its rear end.

A second leaf spring connection means is connected to each said leaf spring 1, 2 at their adjacent ends. The second leaf spring connection means comprises a linkage means in the form of a shackle 6, 7′, which is pivotably connected to a leaf eye of its respective leaf spring 1, 2. Each shackle 6, T is carried on a shackle pin 8, 9′ pivotably attached to a first arm 10, 11′ of a lever 12, 13′ that is supported by a pivotal connection in the form of a spring hanger 14, 15′ attached to the trailer chassis 3. In the example shown, the lever 12, 13′ is substantially L-shaped. As can be seen from the figure, the rear, second leaf spring connection means are substantially identical, but mirrored.

According to the embodiment of FIG. 2, one end of a length adjustable unit 16′ may be attached to the chassis 3 between adjacent ends of the respective leaf springs 1, 2. The length adjustable unit 16′ is fixedly attached to the chassis 3, whereby a displaceable red 22 extends downwards to a position between the adjacent ends of the respective leaf springs 1, 2. The end of the rod 22 extending from the length adjustable unit 16′ is provided with a pivot joint 23 operatively connected to the second arm 18, 19′ of each lever 12, 13′ by means of a pivotable linkage in the form of a pair of second shackles 24, 25. The pivot joint 23 of the length adjustable rod is connected to the respective second arm of each lever 12, 13′ by shackles 24, 25 of substantially equal length. The length adjustable unit 16′ is controllable for stepless adjustment between an upper and a lower end position of the rod 22. An upper end position for the rod 22 can be located so that its pivot joint 23 is located immediately above a line through the pivot joints at the ends of the second arms 18, 19′ of the levers 12, 13′. This provides a self-locking position for the linkage when the suspension is adjusted for maximum ground clearance.

As in the example of FIG. 1, the length adjustable unit comprises an actuator in the form of a rack-and-pinion device 20′ that is hydraulically controlled for length adjustment. A control means (not shown) for actuating the length adjustable unit 16′ can be provided in the drivers compartment, allowing manual and/or automatic control of the unit. An optional spring unit 21′ can be integrated in the length adjustable unit 16′.

The invention is not limited to the embodiments described above, but may be varied freely within the scope of the claims. For instance, the length adjustable unit is not limited to hydraulic actuators, but can be operated and controlled by any suitable mechanical, electrical or fluid means.

1. A front wheel suspension system arranged to support a vehicle chassis suspended for movement relative to its wheels, the suspension system comprising a pair of longitudinally separated leaf springs on each side of the chassis, first leaf spring connection arrangement pivotably connecting each leaf spring to the chassis at a first end, second leaf spring connection arrangement connected to each leaf spring at its opposite, second end by a linkage arrangement which is carried on a pivot pin pivotably attached to a first arm of a lever that is supported by a pivotal connection on the vehicle chassis wherein a length adjustable unit is mounted on each side of the chassis, and each length adjustable unit being operatively connected to a second arm of lever for each leaf spring, wherein each length adjustable unit is arranged to effect a substantially vertical displacement of the second end of each leaf spring relative to the chassis.

2. A wheel suspension system according to claim 1, wherein each end of the length adjustable unit is operatively connected to a lever that is arranged to carry a rear end of the respective leaf spring.

3. A wheel suspension system according to claim 1, wherein each end of the length adjustable unit is operatively connected to a lever that is arranged to carry a front end of the respective leaf spring.

4. A wheel suspension system according to claim 1, wherein one end of the length adjustable unit attached to the chassis between adjacent ends of the respective leaf springs and an opposite end of the length adjustable unit is provided with a pivot joint operatively connected to the second arm of each lever by a pivotable linkage.

5. A wheel suspension system according to claim 4, wherein the pivot joint of the length adjustable unit is connected to the respective second arm by shackles of substantially equal length.

6. A wheel suspension system according to claim 1, wherein the first leaf spring connection arrangement is a spring hanger arranged to support a leaf spring front or rear eye.

7. A wheel suspension system according to claim 1, wherein the linkage arrangement is a shackle pivotably attached to support a leaf spring front or rear eye.

8. A wheel suspension system according to claim 1, wherein each lever comprises first and second arms joined at a point of intersection and is pivotably attached to the trailer chassis at the point of intersection.

9. A wheel suspension system according to claim 1, wherein the first arm is longer than the second arm.

10. A wheel suspension system according to claim 1, wherein an angle enclosed by the first and second arms is between 45° and 135°.

11. A wheel suspension system according to claim 1, wherein the length adjustable unit is a rack and pinion unit.

12. A wheel suspension system according to claim 1, wherein the length adjustable unit is a ball screw unit.

13. A wheel suspension system according to claim 1, wherein the length adjustable unit is double-acting fluid damper comprising a piston cylinder combination.

14. A wheel suspension system according to claim 1, wherein the length adjustable unit comprises a progressive spring.
